(19) United States
(12) Patent Application Publication
(10) Pub. No.: US 2019/0204442 A1
(43) Pub. Date: Jul. 4, 2019

(54) DETECTION ASSEMBLY, CLEANING ROBOT AND METHOD AND SYSTEM FOR DETECTING WALKING CONDITION THEREOF

(71) Applicants: JIANGSU MIDEA CLEANING APPLIANCES CO., LTD., Suzhou (CN); MIDEA GROUP CO., LTD., Foshan (CN)

(72) Inventors: Jongsik WOO, Suzhou (CN); Yuan LU, Suzhou (CN); Haiyan JIN, Suzhou (CN)

(21) Appl. No.: 16/128,531

(22) Filed: Sep. 12, 2018

Related U.S. Application Data
(63) Continuation of application No. PCT/CN2018/098034, filed on Aug. 1, 2018.

(30) Foreign Application Priority Data
Dec. 29, 2017 (CN) 201711479840.0
Dec. 29, 2017 (CN) 201721920082.7

(51) Int. Cl. G01S 17/42; G01S 17/93; G01S 7/481; G01B 11/24; A47L 11/24; A47L 11/40; A47L 9/28

(52) U.S. Cl. CPC G01S 17/42; G01S 17/93; G01S 7/4816; G01B 11/24; A47L 2201/04; A47L 11/4011; A47L 11/4061; A47L 9/2826; A47L 11/24

(57) ABSTRACT

A detection assembly for a cleaning robot includes: a light emitter, configured to emit test light; a darkroom having an access hole for light to enter the darkroom; a plurality of optical receivers, disposed in pairs in the darkroom and configured to receive light entering the darkroom via the access hole after being emitted by the light emitter and reflected by an external reflective surface and to convert a light intensity signal into an electrical signal; a detection circuit electrically connected to the plurality of optical receivers and configured to perform differential operation processing on the electrical signals of each pair of the optical receivers and to generate an output signal.

### CROSS-REFERENCE TO RELATED APPLICATIONS

This application is a continuation of International Application No. PCT/CN2018/098034, filed on Aug. 1, 2018, which claims priority to Chinese Patent Application No. “201721920082.7” and No. “201711479840.0”, entitled “detection assembly, cleaning robot, method and system for detecting walking condition thereof”, filed on Dec. 29, 2017 by JIANGSU MIDEA CLEANING APPLIANCES CO., LTD. and MIDEA GROUP CO., LTD.

### FIELD

The present disclosure relates to the field of cleaning appliance technology, and in particular to a detection assembly, a cleaning robot, and a method and a system for detecting a walking condition thereof.

### BACKGROUND

In the related art, a current cleaning robot detects an obstacle or a ground with a PSD sensor (i.e., a position sensitive detector) or an infrared sensor. The intensity of the reflected light will have an effect on an output signal of the sensing system. When a material of the obstacle or the ground is of dark color, such as black, the ground will absorb a part of the light, so that the intensity of the reflected light is weakened, which will interfere with a detection result of the sensing system. When there is a strong light source in an external environment, such as sunlight, indoor lighting and the like, it will increase the intensity of the reflected light, which may also interfere with the detection result of the sensing system. In addition, PSD sensors are more expensive and costly.

### SUMMARY

The present disclosure seeks to solve at least one of the problems existing in the related art. For this purpose, the present disclosure provides a detection assembly for a cleaning robot capable of reducing interference of an external environment to a detection result of a walking condition.

The present disclosure also provides a cleaning robot, a method for detecting a walking condition of a cleaning robot and a system for detecting a walking condition of a cleaning robot.

According to a first aspect of the present disclosure, a detection assembly for a cleaning robot includes: a light emitter, configured to emit test light; a darkroom having an access hole for light to enter the darkroom; a plurality of optical receivers, disposed in pairs in the darkroom and configured to receive light entering the darkroom via the access hole after being emitted by the light emitter and reflected by an external reflective surface and to convert a light intensity signal into an electrical signal; a detection circuit electrically connected to the plurality of optical receivers and configured to perform differential operation processing on the electrical signals of each pair of the optical receivers and to generate an output signal.

According to the detection assembly for the cleaning robot in embodiments of the present disclosure, by disposing optical receivers in pairs in the darkroom to collect light intensity information of the light emitted by the light emitter and reflected by the external reflective surface, and converting a light intensity signal into an electrical signal, feeding the electrical signals back to a detection circuit and performing differential operation processing on the electrical signals by the detection circuit, and performing differential operation processing on the electrical signals of each pair of the optical receivers, influence of the external environment on the light intensity may be eliminated by means of a common mode signal, and thus influence of a color of the external reflective surface and the external light intensity on the detection result of the detection assembly is reduced.

According to the detection assembly for the cleaning robot in embodiments of the present disclosure, the detection circuit includes a differential amplifier for differential operation processing, and the differential amplifier has a non-inverting input terminal electrically connected to one of each pair of the optical receivers, an inverting input terminal electrically connected to the other of each pair of the optical receivers, and an output terminal for outputting the output signal.

According to the detection assembly for the cleaning robot in embodiments of the present disclosure, the optical receiver is any one of a phototube, a photomultiplier tube, a photoresistor, a phototransistor, a solar cell, a color sensor, and an image sensor.

In some embodiments, the optical receiver is a photoresistor connected to the detection circuit, and a controller is configured to convert a resistance signal of the photoresistor into a voltage signal and to perform differential processing on the voltage signal.

According to the detection assembly for the cleaning robot in embodiments of the present disclosure, two optical receivers are provided, and the two optical receivers are symmetrically distributed with respect to a central axis of the access hole.

According to the detection assembly for the cleaning robot in embodiments of the present disclosure, the detection assembly further includes a lens disposed toward the light emitter to converge the test light emitted by the light emitter.

Optionally, the light emitter, the optical receiver, the darkroom, the detection circuit, and the lens are integrated.

According to a second aspect of the present disclosure, a system for detecting a walking condition of a cleaning robot includes: the detection assembly; and a controller electrically connected to the detection circuit and configured to receive the output signal and to convert the output signal into a spacing value between the detection assembly and the external reflective surface when the output signal is received.

In some embodiments, when the external reflecting surface is an obstacle, the controller is configured to determine that the obstacle exists when the spacing value between the detection assembly and the external reflective surface falls within a preset threshold range, and that no obstacle exists when the spacing value between the detection assembly and the external reflective surface does not fall within the preset threshold range.

In some embodiments, when the external reflective surface is a walking ground, the controller is configured to determine that the walking ground is even when the spacing value between the detection assembly and the external reflective surface falls within a preset threshold range, and that the walking ground is uneven when the spacing value between the detection assembly and the external reflective surface does not fall within the preset threshold range.

In some embodiments, the controller is configured to issue a stop instruction or a turn instruction to control the cleaning robot to stop moving or to turn when the obstacle exists or the walking ground is uneven.

According to a third aspect of the present disclosure, a cleaning robot includes: a body; and the system for detecting the walking condition, in which the detection assembly is located at a bottom and/or a side of the body and configured to detect whether the walking ground is normal through the detection assembly disposed at the bottom of the body and to detect an outer obstacle through the detection assembly disposed at the side of the body.

According to a fourth aspect of the present disclosure, a method for detecting a walking condition of a cleaning robot includes: emitting test light to an external reflective surface; receiving light reflected by the external reflection surface in pairs, and converting a light intensity signal into an electrical signal; performing differential operation processing on each pair of electrical signals and outputting an output signal; converting the output signal into a spacing value between a detection assembly and an external reflective surface, and determining position information of the external reflecting surface according to whether the spacing value falls within a preset threshold range.

In some embodiments, when the spacing value between the detection assembly and the external reflective surface falls within the preset threshold range, it is determined that a walking ground is even or an obstacle is detected; when the spacing value between the detection assembly and the external reflective surface does not fall within the preset threshold range, it is determined that the walking ground is uneven or no obstacle is detected.

Additional aspects and advantages of the present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of the present disclosure will become apparent and more readily appreciated from the following descriptions made with reference to the drawings, in which:

FIG. 1 is a schematic diagram of a detection assembly for a cleaning robot according to an embodiment of the present disclosure.

### REFERENCE NUMERAL

detection assembly 100,
light emitter 1, darkroom 2, access hole 21, optical receiver 3, detection circuit 4, lens 5, external reflection surface a.

### DETAILED DESCRIPTION

Reference will be made in detail to embodiments described herein. The same or similar elements and the elements having same or similar functions are denoted by like reference numerals throughout the descriptions. The embodiments described herein with reference to drawings are illustrative, and presented for generally understanding the present disclosure. The embodiments shall not be construed to be limiting.

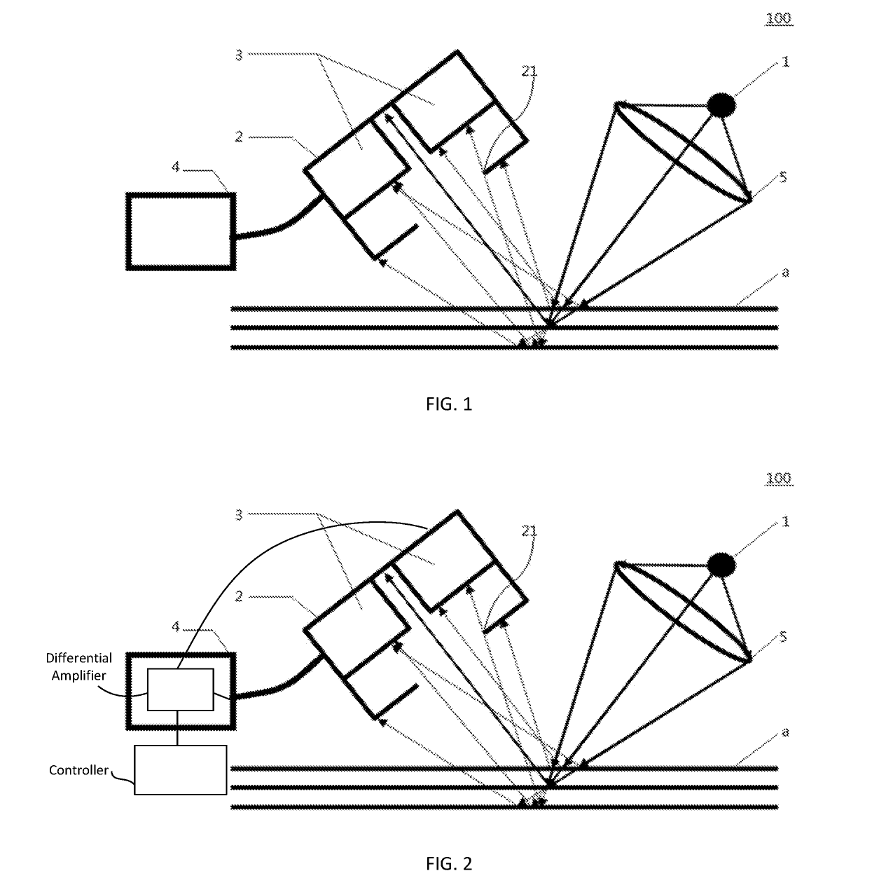

An example detection assembly 100 for a cleaning robot according to the present disclosure is described below with reference to FIG. 1.

As shown in FIG. 1, a detection assembly 100 for a cleaning robot according to the present disclosure includes a light emitter 1, a darkroom 2, a plurality of optical receivers 3, and a detection circuit 4.

The light emitter 1 is configured to emit test light, and the light emitter 1 can use a light source capable of emitting light of a certain color, such as a green light source of 550 nm. The light emitter 1 can emit light toward the underside of the cleaning robot or emit light toward the left, right, front or rear side of the cleaning robot.

The darkroom 2 has an access hole 21 for light to enter the darkroom. The darkroom 2 provides a good collection environment for the light emitted by the light emitter 1 and reflected by an external reflective surface “a”. The darkroom 2 may be chosen to be a light-blocking black box, and the light-blocking black box defines a slit, and only a light beam within a detection range can pass through the slit, in which the slit is formed into the access hole 21.

A plurality of optical receivers 3 are disposed in pairs in the darkroom 2 and are configured to receive the light entering the darkroom 2 via the access hole 21 after being emitted by the light emitter 1 and reflected by the external reflecting surface “a”. The optical receivers 3 can be configured to convert a light intensity signal into an electrical signal.

It should be noted that the external reflection surface a refers to a reflection surface capable of reflecting the light emitted by the light emitter 1. When the external reflection surface a is within a detection range of the detection assembly 100, the light emitted by the light emitter 1 enters the darkroom 2 through the access hole 21 after being reflected by the external reflection surface “a”. Conversely, when the external reflection surface a is not within the detection range of the detection assembly 100, the light emitted by the light emitter 1 cannot enter the darkroom 2 through the access hole 21 after being reflected by the external reflection surface “a”.

The detection circuit 4 is electrically connected to the plurality of optical receivers 3 and configured to perform differential operation processing on the electrical signals of each pair of the optical receivers 3, and to generate an output signal so that light intensity information from the external environment collected by the two optical receivers 3 disposed in pairs is filtered out, thereby eliminating the influence of the external environment on the output signal.

With the detection assembly 100 for the cleaning robot according to embodiments of the present disclosure, the light intensity information of the light emitted by the light emitter 1 and reflected by the external reflecting surface “a” is collected by the optical receivers 3 disposed in pairs in the darkroom 2, and the light intensity information is converted into an electrical signal and the electrical signal is fed back to the detection circuit 4, and the detection circuit 4 performs differential operation processing on the electrical signals fed back by each pair of the optical receivers 3. After differential operation processing on the electrical signals of each pair of the optical receivers 3, influence of the external environment on the light intensity is eliminated by means of a common mode signal, so that influence of the color of the external reflective surface “a” as well as the external light intensity on the detection result of the detection assembly 100 is reduced.

Therefore, the detection assembly 100 for the cleaning robot of the present disclosure has the following advantages: 1. by constructing a common mode signal, the detection circuit 4 is configured to process and remove an interference signal portion (part of which is the influence of the external light source, and part of which is the influence of the color of the obstacle material), thereby improving a sensor detection accuracy; 2. the PSD sensor or the infrared sensor only detects whether the light beam emitted by the emitter is received, and the detection assembly 100 according to embodiments of the present disclosure detects the intensity of light by the optical receiver 3 (including but not limited to a CDS photoresistor) and performs differential operation; 3. the cost is lower.

In order to facilitate the differential operation, the detection circuit 4 includes a differential amplifier having a non-inverting input terminal electrically connected to one of each pair of the optical receivers 3, an inverting input terminal electrically connected to the other of each pair of the optical receivers 3, and an output terminal for outputting the output signal.

The differential amplifier is formed with a differential circuit on the detection circuit 4, and the differential circuit is a circuit having such a function: an input terminal of the circuit is an input of two signals. The difference value between the two signals is an effective input signal of the circuit, and an output of the circuit is an amplification of the difference between the two input signals. Imagine a scenario in which when there is an interference signal, a same interference will be generated for the two input signals. By the difference between the two, an effective input of the interference signal is zero, achieving a purpose of resisting common mode interference.

According to the detection assembly 100 for the cleaning robot in another embodiment of the present disclosure, the optical receiver 3 is any one of a phototube, a photomultiplier tube, a photoresistor, a phototransistor, a solar cell, a color sensor, and an image sensor.

In some embodiments, the optical receiver 3 may be a photoresistor, and the resistance value of the photoresistor may change according to the intensity of the received light, and the change is detected by the detection circuit 4. The photoresistor is connected to the detection circuit 4, and a controller is configured to convert a resistance signal of the photoresistor into a voltage signal and to perform differential processing on the voltage signal.

In the embodiment shown in FIG. 1, two optical receivers 3 are provided, and the two optical receivers 3 are symmetrically distributed with respect to a central axis of the access hole 21.

According to the present disclosure, the detection assembly 100 for the cleaning robot further includes a lens 5 disposed toward the light emitter 1 to converge the test light emitted by the light emitter 1. The lens 5 may be a shift Fresnel lens 5 for testing.

The light emitter 1, the optical receiver 3, the darkroom 2, the detection circuit 4, and the lens 5 may be integrated to form the detection assembly 100, and the entire detection assembly 100 is mounted on the cleaning robot.

According to embodiments of the second aspect of the present disclosure, a system for detecting a walking condition of a cleaning robot includes: the detection assembly 100 according to the above embodiments and a controller electrically connected to the detection circuit 4 and configured to receive the output signal, and to convert the output signal into a spacing value between the detection assembly 100 and the external reflective surface a when the output signal is received.

When the external reflecting surface a is an obstacle, the controller is configured to determine that the obstacle exists when the spacing value between the detection assembly 100 and the external reflective surface a falls within a preset threshold range, and that no obstacle exists when the spacing value between the detection assembly 100 and the external reflective surface a does not fall within the preset threshold range.

When the external reflective surface a is a walking ground, the controller is configured to determine that the walking ground is even when the spacing value between the detection assembly 100 and the external reflective surface a falls within a preset threshold range, and that the walking ground is uneven when the spacing value between the detection assembly 100 and the external reflective surface a does not fall within the preset threshold range.

Accordingly, the light emitter 1 can be configured to emit light toward the underside of the cleaning robot to detect whether the walking ground of the robot is even, and the light emitter 1 can also be configured to emit light toward the left, right, front or rear side of the cleaning robot to enable detection of the obstacle around it.

As a preferred embodiment, the controller is configured to issue a stop instruction or a turn instruction to control the cleaning robot to stop moving or to turn when the obstacle exists or the walking ground is uneven.

According to the detection system for the cleaning robot in embodiments of the present disclosure, the light emitted by the light source is divergent, and is converged by the lens 5 to form an emission beam, which is reflected when the beam hits a surface of the obstacle or a surface of the ground. When the external reflection surface a is within the detection range, the reflected light beam can be taken into the darkroom 2 through the access hole 21, and has a chance to irradiate on the optical receiver 3. After receiving the light beam, an electrical parameter of the optical receiver 3 changes and the change in the electrical parameter is detected by the detected circuit 4. The output signal obtained by differential operation processing is sent to the controller for analysis. The controller determines that information of the external reflection surface a is detected according to an analysis result, and controls a walking component of the cleaning robot (such as a driving wheel or a universal wheel) to perform corresponding operations according to the determination result. When the reflecting surface is not within the proper predetermined range, the reflected beam cannot be taken into the darkroom 2 through the slit, and the optical receiver 3 does not receive the light beam, and the electrical parameter are not changed, and the output signal of the detection circuit 4 are not changed, and the controller determines that the information of the external reflection surface a is not detected.

According to embodiments of the third aspect of the present disclosure, a cleaning robot includes: a body and the system for detecting a walking condition according to the above embodiments, in which the detection assembly 100 is located at a bottom and/or a side of the body and configured to detect whether the walking ground is normal through the detection assembly 100 disposed at the bottom of the body and to detect an outer obstacle through the detection assembly 100 disposed at the side of the body.

Specifically, a circuit board is further provided in a housing of the cleaning robot. The circuit board is configured to install and integrate some electrical components of the cleaning robot and to realize an electrical connection of the various electrical components.

The cleaning robot may include a body, a dust box disposed in the body, a fan, a circuit board and the like. The dust box is configured to accommodate and store dust, hair and the like cleaned by the cleaning robot, and used for implementing a cleaning function of the cleaning robot. Components such as a driving wheel and a universal wheel are provided outside of the body. The driving wheel is configured to realize a movement of the cleaning robot. The universal wheel is configured to realize a turn of the cleaning robot. The controller is configured to control the driving wheel and the universal wheel to perform corresponding operations after receiving the output signal fed back from the detection assembly 100.

For example, when the detection assembly 100 disposed on the left side of the cleaning robot issues an output signal indicating that an obstacle is hit, the controller may control the driving wheel to turn toward the right side to keep away from the obstacle.

A method for detecting a walking condition of a cleaning robot according to embodiments of the fourth aspect of the present disclosure includes S1, S2, S3 and S4.

At S1: test light is emitted to an external reflective surface.

At S2: light reflected by the external reflection surface is received in pairs, and a light intensity signal is converted into an electrical signal.

At S3: differential operation processing is performed on each pair of electrical signals and an output signal is output.

At S4: the output signal is converted into a spacing value between a detection assembly and an external reflective surface, and position information of the external reflecting surface is determined according to whether the spacing value falls within a preset threshold range.

Therefore, by performing differential operation processing on the electrical signals fed back by each pair of optical receivers, after differential operation processing on the electrical signals of each pair of the optical receivers, influence of the external environment on the light intensity is eliminated by means of a common mode signal, so that influence of a color of the external reflective surface as well as the external light intensity on the detection result of the detection assembly is reduced.

According to the method for detecting the walking condition of the cleaning robot according to embodiments of the present disclosure, when the spacing value between the detection assembly 100 and the external reflective surface a falls within the preset threshold range, it is determined that a walking ground is even or an obstacle is detected; when the spacing value between the detection assembly 100 and the external reflective surface a does not fall within the preset threshold range, it is determined that the walking ground is uneven or no obstacle is detected.

In the present invention, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the schematic representation of the above terms throughout this specification are not necessarily referring to the same embodiment or example of the present disclosure. Furthermore, the particular features, structures, materials, or characteristics may be combined in any suitable manner in one or more embodiments or examples. In addition, without contradicting with each other, different embodiments or examples as well as features of various embodiments or examples may be integrate and combined.

Although explanatory embodiments have been shown and described above, it would be appreciated the above embodiments are explanatory and cannot be construed to limit the present disclosure, and changes, variations, alternatives, and modifications can be made in the embodiments by those skilled in the art in the scope of the present disclosure.

1. A detection assembly for a cleaning robot, comprising:
a light emitter, configured to emit test light;
a darkroom configured to block lights from leaving the darkroom and have an access hole, wherein the darkroom is arranged to form an angle with respect to a reflective surface external to the cleaning robot, wherein the angle is configured to facilitate reflection of the test light emitted by the light emitter into the darkroom via the access hole, and wherein the darkroom comprises:
at least one pair of optical receivers configured to receive the light entering the darkroom via the access hole, and to convert a light intensity signal into an electrical signal; and
a detection circuit electrically connected to the at least one pair of optical receivers and configured to perform differential operation processing on the electrical signal generated by each of at least one pair of the optical receivers and to generate an output signal for determining a distance between the detection assembly and the reflective surface, wherein the differential operation processing is configured to determine a difference between the electrical signal generated by each of the at least one pair of the optical receivers.

2. The detection assembly according to claim 1, wherein the detection circuit comprises a differential amplifier for the differential operation processing, wherein differential amplifier has a non-inverting input terminal electrically connected to one of each pair of the optical receivers, an inverting input terminal electrically connected to the other of each pair of the optical receivers, and an output terminal for outputting the output signal.

3. The detection assembly according to claim 1, wherein the optical receiver is any one of a phototube, a photomultiplier tube, a photoresistor, a phototransistor, a solar cell, a color sensor, or an image sensor.

4. The detection assembly according to claim 3, wherein the optical receiver is a photoresistor connected to the detection circuit.

5. The detection assembly according to claim 1, wherein the at least one pair of optical receivers are symmetrically distributed with respect to a central axis of the access hole.

6. The detection assembly according to claim 1, further comprising a lens disposed toward the light emitter to converge the test light emitted by the light emitter.

7. The detection assembly according to claim 1, wherein the light emitter, the optical receiver, the darkroom, the detection circuit, and the lens are integrated.

8. The detection assembly according to claim 1, further comprising a controller configured to determine whether the distance between the detection assembly and the reflective surface is within a preset threshold value and wherein when the distance between the detection assembly and the reflective surface is determined within the preset threshold value, determine the cleaning robot is moving on an even surface.

9. The detection assembly according to claim 8, wherein when the distance between the detection assembly and the reflective surface is determined to breach the preset threshold value, determine the cleaning robot is moving on a uneven surface.

10. A cleaning robot, comprising a detection assembly, wherein the detection assembly comprises:
a light emitter configured to emit test light,
a darkroom configured to block lights from leaving the darkroom and have an access hole, wherein the darkroom comprises:
at least one pair of optical receivers configured to receive the light entering the darkroom via the access hole, and to convert a light intensity signal into an electrical signal;
a detection circuit electrically connected to the at least one pair of optical receivers and configured to perform differential operation processing on the electrical signal generated by each of at least one pair of the optical receivers and to generate an output signal for determining a distance between the detection assembly and the reflective surface, wherein the differential operation processing is configured to determine a difference between the electrical signal generated by each of the at least one pair of the optical receivers, and wherein the detection circuit comprises a differential amplifier for the differential operation processing, wherein
the differential amplifier has a non-inverting input terminal electrically connected to one of each pair of the optical receivers, an inverting input terminal electrically connected to the other of each pair of the optical receivers, and an output terminal for outputting the output signal; and
a lens disposed toward the light emitter to converge the test light emitted by the light emitter.

11. The cleaning robot of claim 10, further comprising a controller configured to determine whether the distance between the detection assembly and the reflective surface is within a preset threshold value and wherein when the distance between the detection assembly and the reflective surface is determined within the preset threshold value, determine the cleaning robot is moving on an even surface.

12. The cleaning robot of claim 10, wherein the detection assembly is located at a bottom and/or a side of a body of the cleaning robot and configured to detect whether the walking ground is normal through the detection assembly disposed at the bottom of the body and to detect an outer obstacle through the detection assembly disposed at the side of the body.

13. The cleaning robot of claim 10, when the distance between the detection assembly and the reflective surface is determined to breach the preset threshold value, determine the cleaning robot is moving on a uneven surface.

14. A method for detecting a walking condition of a cleaning robot, comprising:
emitting test light to an reflective surface external to the cleaning robot;
receiving light reflected by the reflection surface in pairs,
determining a light intensity signal based on the received light;
converting the light intensity signal into an electrical signal;
performing differential operation processing on the electrical signals, wherein the differential operation processing is configured to determine a difference between the electrical signals;
outputting an output signal based on the differential operation processing;
converting the output signal into a distance value between the cleaning robot and the reflective surface; and
determining position information of the reflective surface according to whether the distance value.

15. The method according to claim 14, wherein determining position information of the reflective surface according to the distance value comprises:
when the distance value between the cleaning robot and the reflective surface is within the preset threshold value, determine whether the distance between the cleaning robot and the reflective surface is within a preset threshold value; and
when the distance between the detection assembly and the reflective surface is determined within the preset threshold value, determine the cleaning robot is moving on an even surface.

16. The method according to claim 14, wherein when the distance between the detection assembly and the reflective surface is determined to breach the preset threshold value, determine the cleaning robot is moving on an uneven surface.
